(19) United States
(12) Patent Application Publication
(10) Pub. No.: US 2026/0019886 A1
(43) Pub. Date: Jan. 15, 2026

(54) METHODS AND APPARATUSES FOR HANDLING RESOURCE CONFLICT

(71) Applicant: Lenovo (Beijing) Limited, Beijing (CN)

(72) Inventors: Zhennian Sun, Beijing (CN); Haipeng Lei, Beijing (CN); Xiaodong Yu, Beijing (CN); Xin Guo, Beijing (CN)

(73) Assignee: Lenovo (Beijing) Limited, Beijing (CN)

(21) Appl. No.: 18/993,860

(22) PCT Filed: Jul. 15, 2022
(86) PCT No.: PCT/CN2022/105925

§ 371 Date: Jan. 13, 2025

(51) Int. Cl. H04W 28/26; H04L 27/26; H04W 72/0446; H04W 72/0453; H04W 72/25

(52) U.S. Cl. CPC H04W 28/26; H04L 27/2605; H04W 72/0446; H04W 72/0453; H04W 72/25

(57) ABSTRACT

The present disclosure relates to methods and apparatuses for handling a resource conflict. An embodiment of the present disclosure provides a first user equipment (UE) for wireless communication, comprising: a first sidelink module; a second sidelink module; a transceiver; and a processor coupled with the transceiver and configured to: sense, with both the first sidelink module and the second sidelink module of the first UE, one or more resource conflicts including at least one of: a first type of resource conflict between a first resource reserved by a first sidelink module of a second UE and a second resource reserved by a second sidelink module of any UE, wherein the second UE includes a first sidelink module and no second sidelink module; or a second type of resource conflict between a physical sidelink feedback channel (PSFCH) associated with at least one third resource reserved by the first sidelink module of the second UE and a fourth resource reserved by the second sidelink module of any UE; and transmit, to the second UE, an indicator indicating at least one type of resource conflict.

### TECHNICAL FIELD

The present disclosure relates to sidelink communication, and more specifically relates to methods and apparatus for handling a resource conflict.

### BACKGROUND OF THE INVENTION

In the 3^{rd} generation partnership project (3GPP) Release 16, long term evolution (LTE) vehicle to everything (V2X) and new radio (NR) V2X are designed to coexist in different channels (e.g., in different bands or adjacent channels). However, dedicated V2X spectrum is scarce in some regions, and LTE V2X and NR V2X may need to coexist in the same channel.

For co-channel coexistence between LTE sidelink and NR sidelink, there might be resource conflicts between the resources reserved for LTE sidelink and the resources reserved for NR sidelink, and the present disclosure proposes some solutions for handing the resource conflict.

### SUMMARY

An embodiment of the present disclosure provides a first user equipment (UE) for wireless communication, comprising: a first sidelink module; a second sidelink module; a transceiver; and a processor coupled with the transceiver and configured to: sense, with both the first sidelink module and the second sidelink module of the first UE, one or more resource conflicts including at least one of: a first type of resource conflict between a first resource reserved by a first sidelink module of a second UE and a second resource reserved by a second sidelink module of any UE, wherein the second UE includes a first sidelink module and no second sidelink module; or a second type of resource conflict between a physical sidelink feedback channel (PSFCH) associated with at least one third resource reserved by the first sidelink module of the second UE and a fourth resource reserved by the second sidelink module of any UE; and transmit, to the second UE, an indicator indicating at least one type of resource conflict.

In some embodiments, the first resource and the second resource partially or fully overlap in a time domain

In some embodiments, the PSFCH and the fourth resource partially overlap in a time domain.

In some embodiments, the PSFCH and the fourth resource partially or fully overlap in a frequency domain.

In some embodiments, the processor is configured to transmit the indicator based on a priority level of resource reserved by the second sidelink module being higher than a threshold.

In some embodiments, a PSFCH transmission carrying an indicator indicating the first type of resource and a PSFCH transmission carrying an indicator indicating the second type of resource conflict are associated with different dedicated frequency resources or with different dedicated cyclic shifts.

In some embodiments, a PSFCH transmission carrying an indicator indicating both the first type of resource and the second type of resource conflict is associated with a dedicated frequency resource or a dedicated cyclic shift for a PSFCH transmission carrying an indicator indicating the second type of resource conflict.

In some embodiments, a PSFCH transmission carrying an indicator indicating the first type of resource conflict has a highest priority level among priority levels associated with resources reserved by a second sidelink module of the first UE in a slot with a PSFCH.

In some embodiments, a PSFCH transmission carrying an indicator indicating the second type of resource conflict has a highest priority level among multiple PSFCH transmissions in a slot.

In some embodiments, the first resource or the at least one third resource are sensed by the first sidelink module of the first UE, and the second resource or the fourth resource are sensed by the second sidelink module of the first UE.

Another embodiment of the present disclosure provides a first UE for wireless communication, comprising: a first sidelink module; a transceiver; and a processor coupled with the transceiver and configured to: receive, from a second UE including a first sidelink module and a second sidelink module, an indicator indicating at least one of: a first type of resource conflict between a first resource reserved by a first sidelink module of the first UE and a second resource reserved by a second sidelink module of any UE; or a second type of resource conflict between a PSFCH associated with at least one third resource reserved by the first sidelink module of the first UE and a fourth resource reserved by the second sidelink module of any UE; and perform resource exclusion and resource reselection according to the indicator.

In some embodiments, the first resource and the second resource partially or fully overlap in a time domain.

In some embodiments, the PSFCH and the fourth resource partially overlap in a time domain.

In some embodiments, the PSFCH and the fourth resource partially or fully overlap in a frequency domain.

In some embodiments, a PSFCH reception carrying an indicator indicating the first type of resource and a PSFCH reception carrying an indicator indicating the second type of resource conflict are associated with different dedicated frequency resources or with different dedicated cyclic shifts.

In some embodiments, a PSFCH reception carrying an indicator indicating both the first type of resource and the second type of resource conflict is associated with a dedicated frequency resource or a dedicated cyclic shift for indicator indicating the second type of resource conflict.

In some embodiments, a PSFCH reception carrying an indicator indicating the first type of resource conflict has a highest priority level among priority levels associated with resources reserved by a second sidelink module of the second UE in a slot with a PSFCH.

In some embodiments, a PSFCH reception carrying an indicator indicating the second type of resource conflict has a highest priority level among multiple PSFCH receptions in a slot.

In some embodiments, in the case that the indicator indicates a first type of resource conflict, and the first resources is in a slot with no PSFCH, the processor is further configured to: exclude the first resource from a candidate resource set; and perform resource reselection for the first resource.

In some embodiments, in the case that the indicator indicates a first type of resource conflict, and the first resource is in a slot with a PSFCH, the processor is further configured to: exclude all resources in a slot including the first resource from a candidate resource set; and perform resource reselection for the first resource.

In some embodiments, in the case that the indicator indicates a second type of resource conflict, the processor is further configured to: exclude all resources in a slot including the at least one third resource from a candidate resource set; and perform resource reselection for the at least one third resource.

The first UE of claim 11, in the case that the indicator indicates both a first type of resource conflict and a second type of resource conflict, the processor is further configured to: exclude all resources in a slot including the first resource from a candidate resource set; exclude all resources in a slot including the at least one third resource from a candidate resource set; and perform resource reselection for the first resource and at least one the third resource.

Yet another embodiment of the present disclosure provides a method performed by a first UE including a first sidelink module and a second sidelink module, comprising: sensing, with both the first sidelink module and the second sidelink module of the first UE, one or more resource conflicts including at least one of: a first type of resource conflict between a first resource reserved by a first sidelink module of a second UE and a second resource reserved by a second sidelink module of any UE, wherein the second UE includes a first sidelink module and no second sidelink module; or a second type of resource conflict between a PSFCH associated with at least one third resource reserved by the first sidelink module of the second UE and a fourth resource reserved by the second sidelink module of any UEE; and transmitting, to the second UE, an indicator indicating at least one type of resource conflict.

Still another embodiment of the present disclosure provides a method performed by first UE including a first sidelink module and no second sidelink module, comprising: receiving, from a second UE including a first sidelink module and a second sidelink module, an indicator indicating at least one of: a first type of resource conflict between a first resource reserved by a first sidelink module of the first UE and a second resource reserved by a second sidelink module of any UE; or a second type of resource conflict between a PSFCH associated with at least one third resource reserved by the first sidelink module of the first UE and a fourth resource reserved by the second sidelink module of any UE; and performing resource exclusion and resource reselection according to the indicator.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates a schematic diagram of a wireless communication system according to some embodiments of the present disclosure.

FIG. 1B illustrates some types of UE according to some embodiments of the present disclosure.

FIG. 2A illustrates an exemplary frame structure of LTE V2X according to some embodiments of the present disclosure.

FIG. 2B illustrates an exemplary frame structure for NR V2X according to some embodiments of the present disclosure.

FIG. 3A illustrates a type of resource conflict according to some embodiments of the present disclosure.

FIG. 3B illustrates another type of resource conflict according to some embodiments of the present disclosure.

FIG. 4 illustrates a resource conflict scenario according to some embodiments of the present disclosure.

FIG. 5 illustrates a resource conflict scenario according to some embodiments of the present disclosure.

FIG. 6 illustrates a resource reservation scenario according to some embodiments of the present disclosure.

FIG. 7 illustrates a method performed by a UE for handling a resource conflict according to some embodiments of the present disclosure.

FIG. 8 illustrates a method performed by another UE for handling a resource conflict according to some embodiments of the present disclosure.

FIG. 9 illustrates a simplified block diagram of an exemplary apparatus for handling a resource conflict according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3^{rd} generation partnership project (3GPP) 3G, LTE, LTE-Advanced (LTE-A), 3GPP 4G, 3GPP 5G NR, 3GPP Release 16 and onwards, etc. It can be contemplated that along with the developments of network architectures and new service scenarios, all embodiments in the present disclosure are also applicable to similar technical problems; and moreover, the terminologies recited in the present disclosure may change, which should not affect the principle of the present disclosure.

Embodiments of the present disclosure may relate to coexistence between LTE V2X and NR V2X. It can be contemplated that all embodiments in the present disclosure are also applicable to similar technical problems in coexistence between other different radio access technologies (RATs).

User equipment (UE) under NR V2X scenario and/or LTE V2X scenario may be referred to as V2X UE(s). A V2X UE which transmits data on sidelink may be referred to as a UE for transmitting, a transmitting UE, a transmitting V2X UE, a Tx UE, a V2X Tx UE, a sidelink (SL) Tx UE, or the like. A V2X UE which receives data on sidelink may be referred to as a UE for receiving, a receiving UE, a receiving V2X UE, an Rx UE, a V2X Rx UE, an SL Rx UE, or the like.

V2X UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like.

According to some embodiments of the present disclosure, V2X UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present disclosure, V2X UE(s) may include wearable devices, such as smart watches, fitness bands, optical head-mounted displays, or the like. Moreover, V2X UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. V2X UE(s) may communicate directly with base station(s) (BSs) via communication signals.

A BS under NR V2X scenario and/or LTE V2X scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

A BS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME), a serving gateway (SGW), and/or a packet data network gateway (PGW).

ABS may serve a number of V2X UEs within a serving area, for example, a cell or a cell sector via a wireless communication link. A BS may communicate directly with one or more V2X UEs via communication signals. For example, a BS may serve V2X UEs within a macro cell.

Sidelink communication between a Tx UE and a receiving (Rx) UE under NR V2X scenario includes groupcast communication, unicast communication, or broadcast communication.

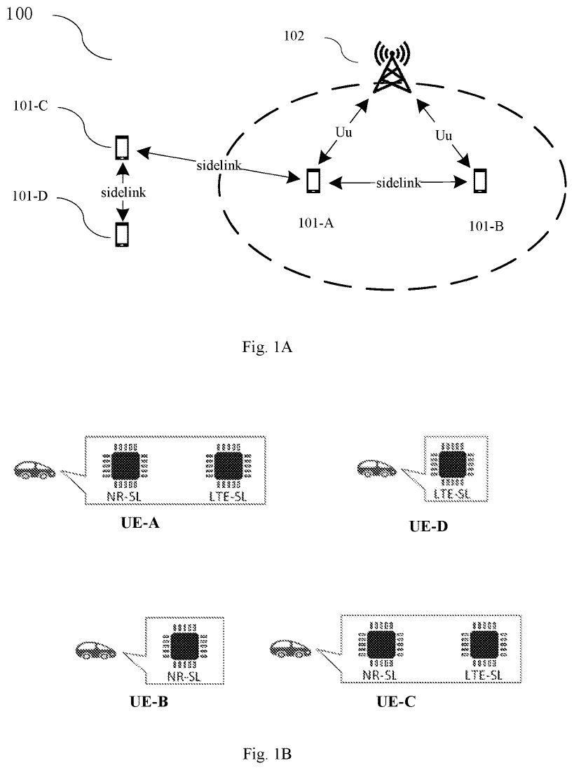

FIG. 1A illustrates an exemplary wireless communication system 100 (e.g., a V2X communication system) in accordance with some embodiments of the present disclosure.

As shown in FIG. 1A, the wireless communication system 100 includes a base station (e.g., BS 102), and some UEs (e.g., UE 101-A, UE 101-B, UE 101-C, and UE 101-D). UE 101-A and UE 101-B are within the coverage of BS 102, and UE 101-C and UE 101-D are outside the coverage of BS 102. UE 101-A, UE 101-B, UE 101-C, and UE 101-D may perform sidelink unicast transmission, sidelink groupcast transmission, or sidelink broadcast transmission. UE 101-A, UE 101-B, UE 101-C, and UE 101-D may be referred to as a V2X UE. It can be contemplated that, in accordance with some other embodiments of the present disclosure, a V2X communication system may include more BSs and more or fewer V2X UEs.

In addition, although the V2X UEs as shown in FIG. 1A are illustrated in the shape of a cellphone, it can be contemplated that a V2X communication system may include any type of UE (e.g., a roadmap device, a cell phone, a computer, a laptop, IoT device or other type of device) in accordance with some other embodiments of the present disclosure.

According to some embodiments of FIG. 1A, UE 101-A may function as a Tx UE, and UE 101-B, UE 101-C, and UE 101-D may function as Rx UEs. UE 101-A may exchange V2X messages with UE 101-B or UE 101-C through a sidelink using, for example, the NR technology or the LTE technology, through PC5 interface as defined in 3GPP documents. UE 101-A may transmit information or data to other UE(s) within the V2X communication system through sidelink unicast, sidelink groupcast, or sidelink broadcast. For instance, UE 101-A may transmit data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Alternatively, according to some other embodiments of FIG. 1A, UE 101-B or UE 101-C may function as a Tx UE and transmit information or data, and UE 101-A may function as an Rx UE and receive information or data from UE 101-B or UE 101-C.

Both UE 101-A and UE 101-B in the embodiments of FIG. 1A may transmit information to BS 102 and receive control information from BS 102, for example, via a Uu interface. BS 102 may define one or more cells, and each cell may have a coverage area. As shown in FIG. 1A, both UE 101-A and UE 101-B are within the coverage of BS 102, while UE 101-C and UE 101-D are not.

The BS 102 as illustrated and shown in FIG. 1A may not be a specific base station, but may be any base station(s) in the V2X communication system. For example, assuming that the V2X communication system includes two BSs, UE 101-A being within a coverage area of any one the two BSs may be called as a case that UE 101-A is within the coverage of a BS in the V2X communication system; and only UE 101-A being outside of coverage area(s) of both BSs can be called as a case that UE 101-A is outside of the coverage of a BS in the V2X communication system.

UEs may operate in different modes. At least the following two sidelink resource allocation modes are defined for sidelink communication: resource allocation mode 1: a BS schedules a sidelink resource(s) to be used by a UE for sidelink transmission(s); and resource allocation mode 2: a UE determines a sidelink transmission resource(s) within sidelink resources configured by a BS or network, or pre-configured sidelink resources. In resource allocation mode 2, a BS does not schedule the sidelink resources for a UE. In FIG. 1A, UE 101-A and UE 101-B may be in resource allocation mode 1, and UE 101-C and UE 101-D may be in resource allocation mode 2. In some other embodiments, UE 101-A and UE 101-B may also be in resource allocation mode 2.

The solutions of the present disclosure may be performed by a UE in resource allocation mode 2.

FIG. 1B illustrates some types of UEs according to some embodiments of the present disclosure.

Four UEs are shown in FIG. 1B: UE-A and UE-C are devices equipped with both the LTE sidelink module and the NR sidelink module, UE-B is equipped with the NR sidelink module only, and UE-D is equipped with the LTE sidelink module only. These UEs may exist when dynamic resource sharing is configured for co-channel coexistence between LTE sidelink and NR sidelink.

For UE-A and UE-C, which include both the LTE sidelink module and the NR sidelink module, the NR sidelink module could perform resource selection based on the internal UE coordination between the LTE sidelink module and the NR sidelink module to avoid resource conflict, for example, the LTE sidelink module may inform its sensing results to the NR sidelink module, similarly, the NR sidelink module may inform its sensing results to the LTE sidelink module, accordingly, UE-A and UE-C may sense (or detect, identify, etc.) the reservations for LTE sidelink and NR sidelink. Hereinafter in the present disclosure, “sense,” “detect,” or “identify” may be used interchangeably where appropriate.

For UE-B, which includes the NR sidelink module only, it cannot sense the resources reserved by LTE sidelink, e.g., resources reserved by the LTE sidelink modules of UE-A or UE-C and resources reserved by the LTE sidelink module of UE-D.

For UE-D, which includes the LTE sidelink module only, it cannot sense the resources reserved by the NR sidelink, e.g., resources reserved by the NR sidelink modules of UE-A or UE-C and resources reserved by the NR sidelink module of UE-B.

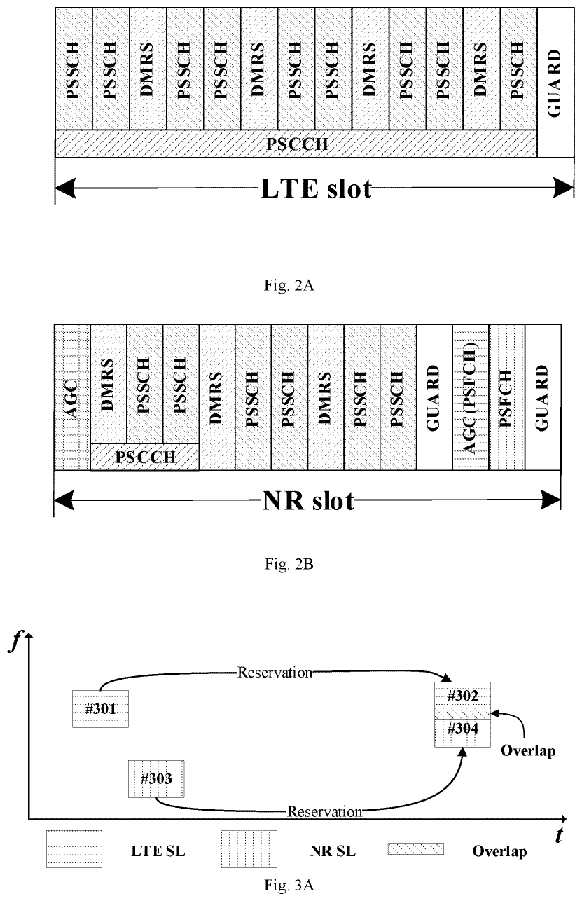

FIG. 2A illustrates an exemplary frame structure of LTE V2X according to some embodiments of the present disclosure. 14 symbols are included in one slot. In particular, 9 symbols for the PSSCH, 4 symbols for the demodulation reference signal (DMRS), and a symbol for the guard interval are included. The last symbol, marked by “GUARD”, is guard time or guard interval, which is the time between the symbols, which is used to prevent inter-symbol interference.

FIG. 2B illustrates an exemplary frame structure for NR V2X according to some embodiments of the present disclosure, wherein a symbol for the PSFCH is included. 14 symbols are included in one slot. In particular, a symbol for the automatic gain control (AGC), a 3-symbol PSCCH, 6 symbols for the PSSCH, 3 symbols for the DMRS, a symbol for the AGC (PSFCH), a symbol for the PSFCH, and two symbols for guard intervals are included.

As can be seen, the frame structures for LTE V2X and NR V2X are different, and this might bring an AGC issue when LTE V2X and NR V2X are transmitted simultaneously, even if they are transmitted on different frequencies.

In the present disclosure, several types of resource conflicts are defined as follows:

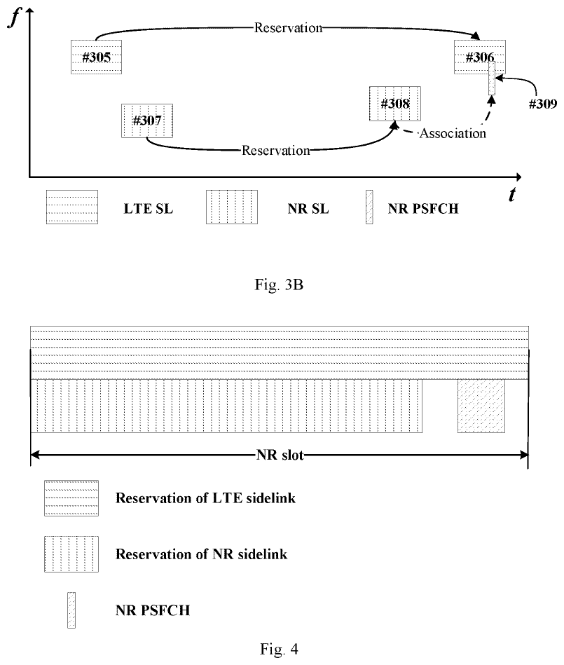

FIG. 3A illustrates a type of resource conflict according to some embodiments of the present disclosure.

In FIG. 3A, resource #301 is used for LTE sidelink, and in resource #301, an LTE module of a UE makes a reservation to reserve sidelink resource #302 for LTE sidelink. Resource #303 is used for NR sidelink, and in resource #303, an NR module of a UE makes a reservation to reserve sidelink resource #304 for NR sidelink. As can be seen, LTE sidelink resource #302 and NR sidelink resource #304 overlap in the time domain and in the frequency domain. Accordingly, there is a resource conflict between LTE sidelink resource #302 and NR resource #304. In some other embodiments, one LTE sidelink resource and one NR resource may have two different durations, and the two different durations may partially or completely overlap in the time domain, no matter whether the two sidelink resources overlap in the frequency domain, there is an AGC issue for LTE sidelink reception.

Hereinafter in the present disclosure, this type of resource conflict between a sidelink resource reserved by an NR module of one UE (or any UE) and a sidelink resource reserved by an LTE module of another UE (or any UE) is referred to as the first type of resource conflict.

FIG. 3B illustrates another type of resource conflict according to some embodiments of the present disclosure.

In FIG. 3B, resource #305 is used for LTE sidelink, and in resource #305, an LTE module of a UE makes a reservation to reserve sidelink resource #306 for LTE sidelink. Resource #307 is used for NR sidelink, and in resource #307, an NR module of a UE makes a reservation to reserve sidelink resource #308 for NR sidelink. The NR sidelink on resource #308 is associated with an NR PSFCH transmission, for example, a PSFCH carrying an indicator or a PSFCH carrying HARQ feedback, which is transmitted with resource #309 in FIG. 3B. As can be seen, LTE sidelink resource #306 and resource #309 for the NR PSFCH transmission overlap in both the time domain and the frequency domain, which may bring an AGC issue. Accordingly, there is a resource conflict between LTE sidelink resource #306 and NR PSFCH #309, and hereinafter in the present disclosure, this type of resource conflict between a PSFCH associated with a resource reserved by the NR sidelink module of one UE (or any UE) and a sidelink resource reserved by an LTE module of another UE (or any UE) is referred to as the second type of resource conflict. It refers to when a resource for the PSFCH transmission associated with a resource reserved by an NR module of one UE and a resource reserved by an LTE module of another UE overlap in the time domain. In some other cases, the resource for the PSFCH transmission associated with a resource reserved by an NR module of one UE and the resource reserved by an LTE module of another UE that overlaps in the time domain or overlap in both the time domain and the frequency domain.

The two types of resource conflicts may be sensed or detected by a UE with both an LTE module and an NR module. For such a UE, the LTE module may sense the LTE sidelink resources reserved by the LTE module of any UE, the NR module may sense the NR sidelink resources reserved by the NR module of any UE, as well as the resources for PSFCH transmission associated with resources reserved by the NR module of any UE, and the two modules can coordinate with each other, such that the two types of resource conflicts are sensed by the UE. The two types of resource conflicts may be expected, or may be potential, in some cases, although they may be sensed but they may not actually occur. Accordingly, these resource conflicts may be referred to as potential or expected resource conflicts.

In order to solve the issues caused by the above resource conflicts, the present disclosure proposes some solutions as follows:

### Solution 1

Regarding the first type of resource conflict, two different cases are presented as follows:

Case 1-1: the potential or expected first type of resource conflict happens in a slot configured without a PSFCH.

In this case, the inter-UE coordination scheme 2 defined in R17 sidelink enhancement may be reused, and is presented as follows:

Inter-UE coordination scheme 2 defined in R17 sidelink enhancement:
In scheme 2, at least the following is supported to determine inter-UE coordination information:
   Among a resource(s) indicated by UE-B's sidelink control information (SCI), UE-A considers that an expected or potential resource conflict occurs on the resource(s) satisfying at least one of the following condition(s):
      Condition 2-A-1:
         Other UE's reserved resource(s) identified by UE-A fully/partially overlaps a resource(s) indicated by UE-B's SCI in time-and-frequency
      Condition 2-A-2:
         A resource(s) (e.g., slot(s)) where UE-A, when it is the intended receiver of UE-B, does not expect to perform SL reception from UE-B due to a half duplex operation

A resource pool level (pre-) configuration can enable one of the following options:
Option 1:
   For Condition 2-A-1 of Scheme 2, support the following additional criteria to determine a resource(s) where expected or potential resource conflict occurs
      For the case when UE-A is a destination UE of a TB transmitted by UE-B
         The resource(s) fully or partially overlaps in time-and-frequency with other UE's reserved resource(s) whose RSRP measurement is larger than a RSRP threshold according to the priorities included in the SCI:
         prio_TX and prio_RX are the priorities indicated in the SCI making the overlapping reservations for UE-B and other UE respectively.
      For the case when UE-A is a destination UE of a TB transmitted by another UE
         The resource(s) fully or partially overlaps in time-and-frequency with other UE's reserved resource(s) when RSRP measurement of UE-B's reserved resource is larger than a RSRP threshold according to the priorities included in the SCI:
         prio_TX and prio_RX are the priorities indicated in the SCI making the overlapping reservations for other UE and UE-B respectively.
Option 4:
   For Condition 2-A-1 of Scheme 2, support the following additional criteria to determine a resource(s) where expected or potential resource conflict occurs
      For the case when UE-A is a destination UE of a TB transmitted by UE-B
         The resource(s) fully or partially overlaps in time-and-frequency with other UE's reserved resource(s) whose RSRP measurement is larger than a (pre) configured RSRP threshold compared to the RSRP measurement of UE-B's reserved resource.
      For the case when UE-A is a destination UE of a TB transmitted by another UE
         The resource(s) fully or partially overlaps in time-and-frequency with other UE's reserved resource(s) when RSRP measurement of UE-B's reserved resource is larger than a (pre) configured RSRP threshold compared to the RSRP measurement of the resource(s).
      Support for Option 4 is subject to UE capability

The present disclosure proposes that for case 1-1, the UE with both the LTE module and the LTE module (e.g., UE-A in FIG. 1B) may transmit an indicator to a UE with an NR module only (e.g., UE-B in FIG. 1B) to indicate the first type of resource conflict. The first type of resource conflict may be between an NR resource reserved by the NR sidelink module of UE-B and a second resource reserved by an LTE sidelink module of any UE. The indicator may further indicate that the first type of resource conflict occurs in a slot not configured with a PSFCH. At the UE-B (the UE with an NR module only) side, it may exclude the indicated reserved resource from its candidate resource set, and then perform resource reselection for the indicated reserved resource. For example, as shown in FIG. 3A, the UE with an NR module only may exclude the indicated reserved resource #304 from the candidate resource set.

Case 1-2: the potential or expected first type of resource conflict may occur in the slot configured with a PSFCH.

The NR PSFCH may be configured with a period of 1 slot, 2 slots, or 4 slots within one resource pool. For example, supposing the NR PSFCH is configured with a period of 4 slots within one resource pool, the NR PSFCH may then be configured in slot #3, slot #7, slot #11, etc.

In the slot configured with a PSFCH, if the UE which includes both the NR sidelink module and the LTE sidelink module, e.g., UE-A as shown in FIG. 1B, detects that there is at least one reservation of LTE sidelink in this slot, then the UE may determine that an expected or potential resource conflict occurs on the resource reserved by NR sidelink.

FIG. 4 illustrates a resource conflict scenario according to some embodiments of the present disclosure.

FIG. 4 illustrates an NR slot which is configured with a PSFCH, i.e., there is at least one symbol for PSFCH transmission in the symbols of the NR slot. For two reservations, one is a reservation of an NR sidelink, the other is a reservation of an LTE sidelink, the two reservations overlap in the time domain, and are orthogonal in the frequency domain without overlapping. However, the UE cannot perform the NR sidelink transmission on the NR reservation because it will cause an AGC issue for the reception of the LTE sidelink.

The present disclosure proposes that for case 1-2, the UE with both the LTE module and the LTE module (e.g., UE-A in FIG. 1B) may transmit an indicator to a UE with an NR module only (e.g., UE-B in FIG. 1B) to indicate the first type of resource conflict. The first type of resource conflict may be between a resource reserved by the NR sidelink module of UE-B and a resource reserved by an LTE sidelink module of any UE. The indicator may further indicate that the first type of resource conflict occurs in a slot configured with a PSFCH. At the UE-B (the UE with an NR module only) side, it may exclude all the resources in the slot containing the indicated reserved resource from its candidate resource set, and then perform resource reselection for the indicated reserved resource. For example, as shown in FIG. 3A, it is supposed that the slot include resource #302 and resource #304 is with a PSFCH, then the UE with an NR module only may exclude all the resources in the slot containing resource #304 from its candidate resource set, and may perform resource reselection for resource #304. In this way, the AGC issue may be avoided.

### Solution 2

Regarding the second type of resource conflict, i.e., resource conflict between a PSFCH associated with a resource reserved by the NR sidelink module of one UE (or any UE) and a sidelink resource reserved by an LTE module of another UE (or any UE), the UE which includes both the LTE sidelink module and NR sidelink module, e.g., UE-A as shown in FIG. 1B, may sense the second type of resource conflict. In particular, based on the sensing performed by both the NR module and the LTE sidelink module of UE-A, UE-A may determine the second type of resource conflict, and two different cases are presented as follows:

### Case 2-1:

a) HARQ feedback is enabled for the resource reserved by the NR sidelink module of the UE that includes the NR sidelink module only, in other words, the reserved resource is associated with a PSFCH for the HARQ feedback transmission; and
b) The PSFCH for the HARQ feedback transmission and a resource reserved by an LTE sidelink module of any UE partially overlaps in time a domain and fully/partially overlaps in the frequency domain.

For example, as shown in FIG. 3B, resource #309 for the PSFCH and resource #306 partially overlap in the time domain and partially overlap in the frequency domain. UE-A determines that there is the second type of resource conflict between the PSFCH and resource #306, and may transmit an indicator, which indicates the second type of resource conflict, to the UE that reserves resource #308, which is associated with the PSFCH.

### Case 2-2:

a) HARQ feedback is enabled for the resource reserved by the NR sidelink module of the UE that includes the NR sidelink module only, in other words, the reserved resource is associated with a PSFCH for the HARQ feedback transmission; and
b) The PSFCH for the HARQ feedback transmission and a resource reserved by LTE sidelink are partially overlapping in the time domain. That is, as long as the PSFCH and a resource reserved by LTE sidelink are partially overlapping in the time domain, there is a second type of resource conflict between the PSFCH and the resource, regardless of whether the resources are overlapping or not in the frequency domain.

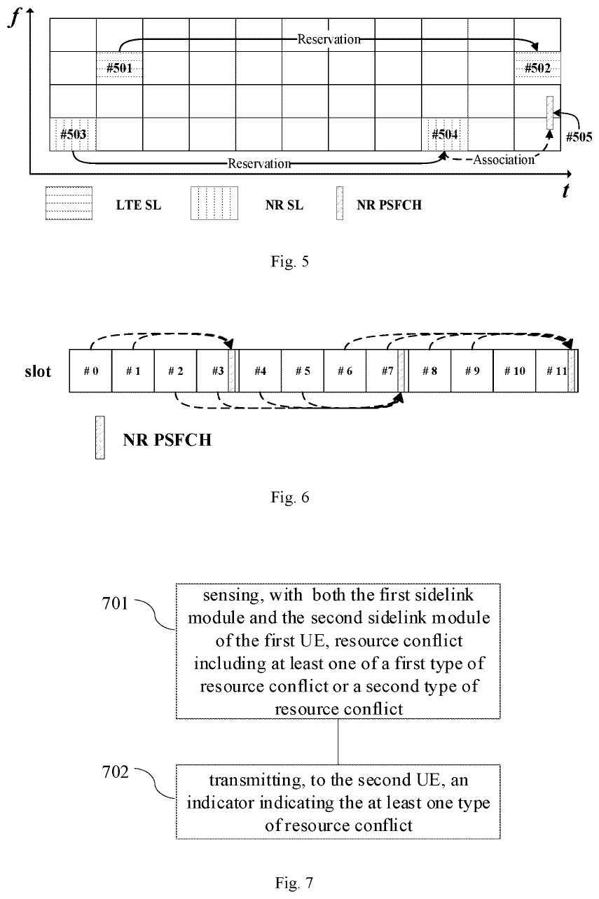

The resource conflict described in case 2-2 is further explained by referring to FIG. 5. FIG. 5 illustrates a resource conflict scenario according to some embodiments of the present disclosure.

In FIG. 5, resource #501 is used for LTE sidelink, and in resource #501, an LTE module of a UE makes a reservation to reserve sidelink resource #502 for LTE sidelink. Resource #503 is used for NR sidelink, and in resource #503, an NR module of a UE makes a reservation to reserve sidelink resource #504 for NR sidelink. The NR sidelink on resource #504 is associated with an NR PSFCH transmission, for example, a PSFCH carrying an indicator, or a PSFCH carrying HARQ feedback, or other PSFCH transmissions, which is transmitted with resource #505 in FIG. 5. As can be seen, LTE sidelink resource #502 and resource #505 for the NR PSFCH only overlap in the time domain, but do not overlap in the frequency domain. However, according to the relevant content as explained in FIG. 4, this may bring an AGC issue. According to case 2-2, there is a second type of resource conflict between the PSFCH and resource #502, and the UE than senses this resource conflict may transmit an indicator to indicate the UE that reserves resource #504, which is associated with the PSFCH.

For case 2-2, there may be no hardware and specification impact on the current LTE sidelink, and this condition may avoid the AGC issue of LTE sidelink reception compared to case 2-1.

In some embodiments, priority levels may be configured for the reservations by LTE sidelink, and for the PSFCH transmission. The UE that senses the resource conflict may further determine whether to transmit an indicator indicating the other UE based on the priority levels.

For example, the HARQ feedback with “NACK” only is enabled for sidelink groupcast transmission. In the case that all the UEs receive the groupcast transmission correctly, there may be no HARQ feedback. In other words, there may be no PSFCH transmission for the HARQ feedback. In the case that the there is a potential second type of resource conflict between the PSFCH and a resource reserved for LTE sidelink, but the PSFCH transmission is not performed, there is no AGC issue for the LTE sidelink reception. In this scenario, even UE-A senses a second type of resource conflict between the PSFCH transmission and the reserved sidelink resources, since the PSFCH transmission may not be performed, thus UE-A may not transmit the indicator indicating the second type of resource conflict to UE-B.

The present disclosure proposes to determine whether to transmit the indicator based on priority levels associated with the reservations by LTE sidelink, and the priority level associated with the PSFCH transmission to solve the above issue. For example, a priority threshold may be configured or preconfigured. In the case that the highest priority level of the reservations by LTE sidelink is higher than the configured threshold, UE-A may transmit the indicator, otherwise UE-A may not transmit the indicator.

In some other embodiments, the priority levels associated with the PSFCH carrying the indicator may be configured as follows:
a) For case 2 and case 1-2, the priority levels associated with the PSFCH carrying the indicator, which indicates the first type of resource conflict or the second type of resource conflict, may be configured with the highest priority level compared with the priority levels associated with resources reserved by an LTE module of any UE in the slot containing the PSFCH, or
b) the priority levels associated with the PSFCH may be preconfigured, or configured, or
c) The PSFCH carrying the indicator which indicates the second type of resource conflict (i.e., the resource conflict described in solution 2) is prioritized over other PSFCHs. For example, a PSFCH carrying the indicator which indicates the second type of resource conflict is prioritized over a PSFCH carrying HARQ-ACK feedback.

The UE with both the LTE module and the NR module may need to perform the PSFCH transmission or reception according to the priority levels associated with the PSFCH, therefore, it may determine the priority levels for the PSFCH carrying the indicator for the first type of resource conflict and the PSFCH carrying the indicator for the second type of resource conflict.

At the UE with only an NR module side, for example, UE-B as shown in FIG. 1B, it may take different operations based on different types of resource conflicts in different cases as follows:

For case 1-1, UE-B may exclude the indicated reserved resource from its candidate resource set, and then perform resource reselection for the indicated reserved resource.

For case 1-2, UE-B may exclude all the resources in the slot containing indicated reserved resource from its candidate resource set, and then perform resource reselection for the indicated reserved resource

For case 2 (including case 2-1 and case 2-2), UE-B may exclude all the resources in the slot containing the indicated reserved resource from its candidate resource set, and then perform resource reselection for the indicated reserved resource. In some embodiments, UE-B may also exclude all the resources in the slot containing the PSFCH from its candidate resource set.

In some embodiments, in order to distinguish the different types of resource conflicts, the present disclosure proposes some alternatives as follows:

Alternative 1: a PSFCH carrying an indicator indicating the first type of resource conflict (referred to as the first type of indicator for short) and a PSFCH transmission reception carrying an indicator indicating the second type of resource conflict (referred to as the second type of indicator for short) are associated with different dedicated frequency resources. For example, the PSFCH transmission that carries the first type of indicator and the PSFCH transmission that carries the second type of indicator may be associated with different PRBs.

Alternative 2: the PSFCH transmission that carries the first type of indicator and the PSFCH transmission that carries the second type of indicator may be configured with different cyclic shifts. For example, the cyclic shift for the PSFCH transmission that carries the first type of indicator may be configured as 0, i.e., parameter m_cs=0; and the cyclic shift for the PSFCH transmission that carries the second type of indicator may be configured as 6, i.e., parameter m_cs=6.

In the case that both the first type of resource conflict and the second type of resource conflict occurs, the indicator may indicate both the first type of resource conflict and the second type of resource conflict, and the PSFCH transmission carrying this indicator may be associated with the dedicated frequency resource or a dedicated cyclic shift for the PSFCH transmission carrying the indicator indicating the second type of resource conflict.

In some embodiments, there may be multiple reserved resources associated with one PSFCH occasion. For example, FIG. 6 illustrates a resource reservation scenario according to some embodiments of the present disclosure.

In FIG. 6, there are 12 slots, i.e., slot #0, slot #1, slot #2, . . . , slot #11. The PSFCH is configured with a period of 4 slots within the resource pool.

Resources in slot #0 and slot #1 are associated with the PSFCH in slot #3. Resources in slot #2, slot #3, slot #4, and slot #5, are associated with a PSFCH in slot #7. Resources in slot #6, slot #7, slot #8, and slot #9, are associated with a PSFCH in slot #11.

In the case that the UE with only an NR sidelink module receives an indicator, indicating a second type of resource conflict may occur in slot #7, the UE may exclude all the resources in the slot associated with the PSFCH transmission in slot #7, i.e., the UE may exclude all the resources in slot #2, slot #3, slot #4, and slot #5 from its candidate resource set.

FIG. 7 illustrates a method performed by a UE for handling a resource conflict according to some embodiments of the present disclosure.

In operation 701, the first UE may sense, with both the first sidelink module and the second sidelink module of the first UE, one or more resource conflicts including at least one of: a first type of resource conflict between a first resource reserved by a first sidelink module of a second UE and a second resource reserved by a second sidelink module of any UE, wherein the second UE includes a first sidelink module and no second sidelink module; or a second type of resource conflict between a PSFCH associated with at least one third resource reserved by the first sidelink module of the second UE and a fourth resource reserved by the second sidelink module of any UE. In operation 702, the first UE may transmit, to the second UE, an indicator indicating at least one type of resource conflict. The first UE may be UE-A in FIG. 1B, and the second UE may be UE-B in FIG. 1B.

In some embodiments, the first resource and the second resource partially or fully overlap in a time domain. For example, in FIG. 3A, resource #302 and resource #304 fully overlap in a time domain.

In some embodiments, the PSFCH and the fourth resource partially overlap in a time domain. In some embodiments, the PSFCH and the fourth resource partially or fully overlap in a frequency domain. For example, in FIG. 3B, PSFCH in resource #309 and resource #306 partially overlap in the time domain, and partially overlap in the frequency domain.

In some embodiments, the processor is configured to transmit the indicator based on a priority level of resource reserved by the second sidelink module being higher than a threshold.

In some embodiments, a PSFCH transmission carrying an indicator indicating the first type of resource and a PSFCH transmission carrying an indicator indicating the second type of resource conflict are associated with different dedicated frequency resources or with different dedicated cyclic shifts. For example, different PRBs are associated with a PSFCH transmission carrying an indicator indicating the first type of resource and a PSFCH transmission carrying an indicator indicating the second type of resource.

In some embodiments, a PSFCH transmission carrying an indicator indicating both the first type of resource and the second type of resource conflict is associated with a dedicated frequency resource or a dedicated cyclic shift for indicator indicating the second type of resource conflict.

In some embodiments, a PSFCH transmission carrying an indicator indicating the first type of resource conflict has a highest priority level among priority levels associated with resources reserved by a second sidelink module of the first UE in a slot with a PSFCH. In some embodiments, a PSFCH transmission carrying an indicator indicating the second type of resource conflict has a highest priority level among multiple PSFCH transmissions in a slot.

In some embodiments, the first resource or the at least one third resource are sensed by the first sidelink module of the first UE, and the second resource or the fourth resource are sensed by the second sidelink module of the first UE. For example, the NR module of a UE may sense the resources reserved by NR module of any UE, and the LTE module of a UE may sense the resources reserved by LTE module of any UE.

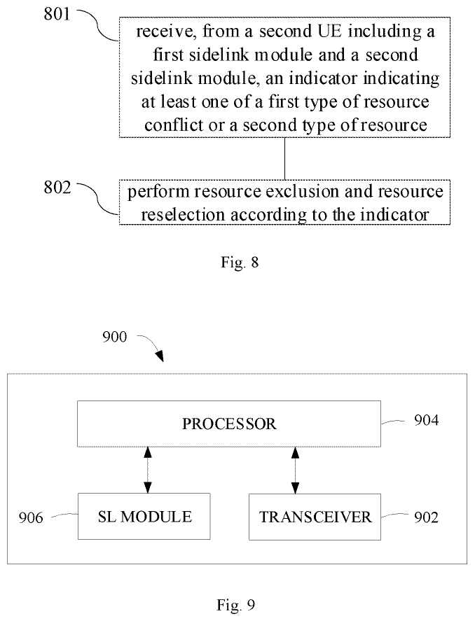

FIG. 8 illustrates a method performed by another UE for handling a resource conflict according to some embodiments of the present disclosure.

In operation 801, the UE may receive, from a second UE including a first sidelink module and a second sidelink module, an indicator indicating at least one of: a first type of resource conflict between a first resource reserved by a first sidelink module of the first UE and a second resource reserved by a second sidelink module of any UE; or a second type of resource conflict between a PSFCH associated with at least one third resource reserved by the first sidelink module of the first UE and a fourth resource reserved by the second sidelink module of any UE. In operation 802, the UE may perform resource exclusion and resource reselection according to the indicator. The first UE may be UE-B in FIG. 1B, and the second UE may be UE-A in FIG. 1B.

In some embodiments, in the case that the indicator indicates a first type of resource conflict, and the first resources is in a slot with no PSFCH, the processor is further configured to: exclude the first resource from a candidate resource set; and perform resource reselection for the first resource. For example, in FIG. 3A, UE-B may exclude resource #304 from a candidate resource set; and perform resource reselection for resource #304.

In some embodiments, in the case that the indicator indicates a first type of resource conflict, and the first resource is in a slot with a PSFCH, the processor is further configured to: exclude all resources in a slot including the first resource from a candidate resource set; and perform resource reselection for the first resource. For example, in FIG. 3B, in the case that the slot including resource #304 is a slot with a PSFCH, UE-B may exclude all resources in a slot including resource #304 from a candidate resource set; and perform resource reselection for resource #304.

In some embodiments, in the case that the indicator indicates a second type of resource conflict, the processor is further configured to: exclude all resources in a slot including the at least one third resource from a candidate resource set; and perform resource reselection for the third resource. For example, in FIG. 3B, UE-B may exclude all resources in a slot including resource #306 from a candidate resource set; and perform resource reselection for resource #306.

In some embodiments, in the case that the indicator indicates both a first type of resource conflict and a second type of resource conflict, the processor is further configured to: exclude all resources in a slot including the first resource from a candidate resource set; exclude all resources in a slot including the at least one third resource from a candidate resource set; and perform resource reselection for the third resource.

FIG. 9 illustrates a simplified block diagram of an exemplary apparatus for handling a resource conflict according to some embodiments of the present disclosure.

As shown in FIG. 9, an example of the apparatus 900 may include at least one processor 904, at least one transceiver 902 coupled to the processor 904, and at least one SL module 906 coupled to the processor 904. In some embodiments, the SL module 906 may include an LTE module and an NR module, in some other embodiments, the SL module may include an LTE module or an NR module, or other SL modules. The apparatus 900 may be a UE with an LTE module and an NR module, a UE with an LTE module, a UE with an NR module, a UE with other SL modules, or any other device with similar functions.

Although in this figure, elements such as the at least one transceiver 902 and processor 904 are described in the singular, the plural can be contemplated unless a limitation to the singular is explicitly stated. In some embodiments of the present disclosure, the transceiver 902 may be divided into two devices, such as a receiving circuitry and a transmitting circuitry. In some embodiments of the present disclosure, the apparatus 900 may further include an input device, a memory, and/or other components.

In some embodiments of the present disclosure, the apparatus 900 may be a UE. The transceiver 902 and the processor 904 may interact with each other so as to perform the operations of the UE described in any of FIGS. 1-8. The transceiver 902, the processor 904, the SL module 906 may interact with each other so as to perform the operations of the node described in any of FIGS. 1-8.

In some embodiments of the present disclosure, the apparatus 900 may further include at least one non-transitory computer-readable medium.

For example, in some embodiments of the present disclosure, the non-transitory computer-readable medium may have stored thereon computer-executable instructions to cause the processor 904 to implement the method with respect to the UE as described above. For example, the computer-executable instructions, when executed, cause the processor 904 interacting with transceiver 902 and the SL module 906 to perform the operations of the UE described in any of FIGS. 1-8.

In some embodiments of the present disclosure, the non-transitory computer-readable medium may have stored thereon computer-executable instructions to cause the processor 904 to implement the method with respect to the node as described above. For example, the computer-executable instructions, when executed, cause the processor 904 interacting with transceiver 902 and the SL module 906 to perform the operations of the node described in any of FIGS. 1-8.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A first user equipment (UE) for wireless communication, comprising:
at least one memory; and
at least one processor coupled with the at least one memory and configured to cause the first UE to:
sense one or more resource conflicts including at least one of:
a first type of resource conflict between a first resource reserved by a first sidelink module of a second UE and a second resource reserved by a second sidelink module of any UE; or
a second type of resource conflict between a physical sidelink feedback channel (PSFCH) associated with at least one third resource reserved by the first sidelink module of the second UE and a fourth resource reserved by the second sidelink module of any UE; and
transmit an indicator indicating at least one type of resource conflict.

2. The first UE of claim 1, wherein the first resource and the second resource partially or fully overlap in a time domain.

3. The first UE of claim 1, wherein the PSFCH and the fourth resource partially overlap in a time domain.

4. The first UE of claim 2, wherein the PSFCH and the fourth resource partially or fully overlap in a frequency domain.

5. The first UE of claim 1, wherein the at least one processor is configured to cause the first UE to transmit the indicator based on a priority level of the second resource or the fourth resource being higher than a threshold.

6. The first UE of claim 1, wherein a PSFCH transmission carrying an indicator indicating the first type of resource conflict and a PSFCH transmission carrying an indicator indicating the second type of resource conflict are associated with different dedicated frequency resources or with different dedicated cyclic shifts.

7. The first UE of claim 1, wherein a PSFCH transmission carrying an indicator indicating both the first type of resource conflict and the second type of resource conflict are associated with a dedicated frequency resource or a dedicated cyclic shift for a PSFCH transmission carrying an indicator indicating the second type of resource conflict.

8. The first UE of claim 1, wherein a PSFCH transmission includes an indicator indicating the first type of resource conflict has a highest priority level among priority levels associated with resources reserved by a sidelink module of the first UE in a slot with PSFCH.

9. The first UE of claim 1, wherein a PSFCH transmission includes an indicator indicating the second type of resource conflict has a highest priority level among multiple PSFCH transmissions in a slot.

10. The first UE of claim 1, wherein the first resource or the at least one third resource are sensed by a first sidelink module of the first UE, and the second resource or the fourth resource are sensed by a second sidelink module of the first UE.

11. A first user equipment (UE) for wireless communication, comprising:
at least one memory, and
at least one processor coupled with the at least one memory and configured to cause the first UE to:
receive an indicator indicating at least one of:
a first type of resource conflict between a first resource reserved by a first sidelink module of the first UE and a second resource reserved by a second sidelink module of any UE; or
a second type of resource conflict between a physical sidelink feedback channel (PSFCH) associated with at least one third resource reserved by the first sidelink module of the first UE and a fourth resource reserved by the second sidelink module of any UE; and
perform resource exclusion and resource reselection according to the indicator.

12. The first UE of claim 11, wherein in a case that the indicator indicates the first type of resource conflict, and the first resource is in a slot with no PSFCH, the at least one processor is further configured to cause the first UE to:
exclude the first resource from a candidate resource set; and
perform resource reselection for the first resource.

13. The first UE of claim 11, wherein in a case that the indicator indicates the first type of resource conflict, and the first resource is in a slot with PSFCH, the at least one processor is further configured to cause the first UE to:
exclude all resources in a slot including the first resource from a candidate resource set; and
perform resource reselection for the first resource.

14. The first UE of claim 11, wherein in a case that the indicator indicates the second type of resource conflict, the at least one processor is further configured to cause the first UE to:
exclude all resources in a slot including the at least one third resource from a candidate resource set; and
perform resource reselection for the at least one third resource.

15. (canceled)

16. A processor for wireless communication, comprising:
at least one controller coupled with at least one memory and configured to cause the processor to:
sense one or more resource conflicts including at least one of:
a first type of resource conflict between a first resource reserved by a first sidelink module of a first user equipment (UE) and a second resource reserved by a second sidelink module of any UE; or
a second type of resource conflict between a physical sidelink feedback channel (PSFCH) associated with at least one third resource reserved by the first sidelink module of the first UE and a fourth resource reserved by the second sidelink module of any UE; and
transmit an indicator indicating at least one type of resource conflict.

17. The processor of claim 16, wherein the first resource and the second resource partially or fully overlap in a time domain.

18. The processor of claim 16, wherein the PSFCH and the fourth resource partially overlap in a time domain.

19. A processor for wireless communication, comprising:
at least one controller coupled with at least one memory and configured to cause the processor to:
receive an indicator indicating at least one of:
a first type of resource conflict between a first resource reserved by a first sidelink module of a first user equipment (UE) that includes the processor and a second resource reserved by a second sidelink module of any UE; or
a second type of resource conflict between a physical sidelink feedback channel (PSFCH) associated with at least one third resource reserved by the first sidelink module of the first UE and a fourth resource reserved by the second sidelink module of any UE; and
perform resource exclusion and resource reselection according to the indicator.

20. The processor of claim 19, wherein in a case that the indicator indicates the first type of resource conflict, and the first resource is in a slot with no PSFCH, the at least one controller is further configured to cause the processor to:
exclude the first resource from a candidate resource set; and
perform resource reselection for the first resource.

21. The processor of claim 19, wherein in a case that the indicator indicates the first type of resource conflict, and the first resource is in a slot with PSFCH, the at least one controller is further configured to cause the processor to:
exclude all resources in a slot including the first resource from a candidate resource set; and
perform resource reselection for the first resource.
